(19) United States
(12) Patent Application Publication
(10) Pub. No.: US 2018/0046369 A1
(43) Pub. Date: Feb. 15, 2018

(54) ON-BOARD OPERATION DEVICE

(71) Applicant: Honda Motor Co.,Ltd., Tokyo (JP)

(72) Inventors: Hironori TAKANO, Saitama (JP); Ryosuke TANAKA, Saitama (JP); Genta BODA, Saitama (JP); Naotoshi FUJIMOTO, Saitama (JP)

(73) Assignee: Honda Motor Co.,Ltd., Tokyo (JP)

(21) Appl. No.: 15/658,406

(22) Filed: Jul. 25, 2017

(30) Foreign Application Priority Data
Aug. 9, 2016 (JP) 2016-156428

(51) Int. Cl. G06F 3/0488; G06F 3/0482; G06F 3/0484

(52) U.S. Cl. CPC G06F 3/04886; G06F 3/04845; G06F 3/0482; G06F 2203/04108; G06F 3/044

(57) ABSTRACT

An on-board operation device with improved operability is provided. The on-board operation device includes: a display unit configured to display a GUI object; a first detection unit configured to detect an approach position of an indicator on a display surface of the display unit; a process performing unit configured to perform a process corresponding to the GUI object displayed at the approach position detected by the first detection unit; a second detection unit disposed at an outer edge of the display surface of the display unit and configured to detect an approach position of the indicator; and a display control unit configured to enlarge and display the GUI object on the display unit when the approach position of the indicator is detected by the second detection unit.

### CROSS-REFERENCE TO RELATED APPLICATION

This application claims the priority benefit of Japan Application no. 2016-156428, filed on Aug. 9, 2016. The entirety of the above-mentioned patent application is hereby incorporated by reference herein and made a part of this specification.

### BACKGROUND OF THE INVENTION

### Field of the Invention

The present invention relates to an on-board operation device.

### Description of Related Art

A technique of enlarging and displaying a predetermined area centered on a set of coordinates approached on a touch panel type display device when an approach of a finger to a touch panel is sensed has been disclosed (for example, Patent Document 1).

### PRIOR ART DOCUMENT

### Patent Documents

[Patent Document 1] Japanese Patent No. 5675622

### SUMMARY OF THE INVENTION

However, in the related art, since a set of coordinates on a screen is determined and an area centered on the determined set of coordinates is enlarged before a finger touches the touch panel, there is a possibility that an area which is not desired by an operator will be enlarged and displayed.

The invention is made in consideration of the above-mentioned circumstances and an object thereof is to provide an on-board operation device that can improve operability.

According to a first aspect of the invention, there is provided an on-board operation device including: a display unit configured to display a GUI object; a first detection unit configured to detect an approach position of an indicator on a display surface of the display unit; a process performing unit configured to perform a process corresponding to the GUI object displayed at the approach position detected by the first detection unit; a second detection unit disposed at an outer edge of the display surface of the display unit and configured to detect an approach position of the indicator; and a display control unit configured to enlarge and display the GUI object on the display unit when the approach position of the indicator is detected by the second detection unit.

A second aspect of the invention provides the on-board operation device according to the first aspect, wherein a plurality of the GUI objects are displayed on the display unit, and the display control unit enlarges and displays the GUI object corresponding to the approach position among the plurality of GUI objects on the display unit based on the approach position of the indicator detected by the second detection unit.

A third aspect of the invention provides the on-board operation device according to the second aspect, wherein the display control unit enlarges and displays the GUI object corresponding to the approach position to at least a side opposite to a side on which the second detection unit is disposed on the display unit.

A fourth aspect of the invention provides the on-board operation device according to any one of the first to third aspects, wherein the display control unit enlarges and displays the GUI object on the display unit by detecting a touch on the second detection unit with the indicator.

A fifth aspect of the invention provides the on-board operation device according to any one of the first to fourth aspects, wherein the plurality of GUI objects are displayed to be biased to an end of the display surface, and the second detection unit is disposed along the end to which the plurality of GUI objects are biased.

A sixth aspect of the invention provides the on-board operation device according to any one of the first to fifth aspects, wherein the second detection unit is provided with boundary lines which are visually recognizable or tactually recognizable to correspond to shapes of the GUI objects displayed on the display unit.

A seventh aspect of the invention provides the on-board operation device according to any one of the first to sixth aspects, wherein the second detection unit is formed to be inclined forward with respect to the display surface of the display unit.

An eighth aspect of the invention provides the on-board operation device according to any one of the first to seventh aspects, wherein the second detection unit includes a capacitance sensor.

A ninth aspect of the invention provides the on-board operation device according to any one of the first to eighth aspects, wherein details correlated with a page displayed on the display unit are assigned to the GUI objects and the GUI objects are normally displayed on a display screen of any layer regardless of the details displayed on the display screen.

A tenth aspect of the invention provides the on-board operation device according to any one of the first to ninth aspects, wherein the display control unit displays an area in which the GUI objects are displayed and an area in which results of processes corresponding to the GUI objects are displayed on the display surface of the display unit.

According to the first and tenth aspects of the invention, it is possible to improve operability of the on-board operation device.

According to the second and eighth aspects of the invention, it is possible to easily enlarge and display a GUI object desired by an operator based on the detection result of the second detection unit.

According to the third and ninth aspects of the invention, when a plurality of GUI objects are arranged, it is possible to enlarge and display a target GUI object without hiding another GUI object.

According to the fourth aspect of the invention, since display control for the display unit can be performed on the assumption that the second detection unit has reliably been touched with the indicator, it is possible to prevent an erroneous operation.

According to the fifth aspect of the invention, after the GUI object displayed on the display unit is enlarged and displayed based on the detection result of the second detection unit, an operator can perform an operation of selecting the GUI object by only slightly moving the indicator. Accordingly, it is possible to improve operability.

According to the sixth aspect of the invention, an operator can easily select a target GUI object.

According to the seventh aspect of the invention, since an approach of an operator's finger can be easily detected by the second detection unit earlier than by the first detection unit, the GUI object can be enlarged and displayed before the display surface of the display unit is touched with the finger. Accordingly, the operator can easily select a target GUI object.

### BRIEF DESCRIPTION OF THE DRAWINGS

FIG. 1 is a diagram schematically illustrating a vehicle 1 which is equipped with an on-board operation device according to an embodiment.

FIG. 2 is a diagram illustrating an example of a functional configuration of an on-board operation device 40.

FIG. 3 is a diagram illustrating an arrangement example of GUI objects 42A which are displayed on a display unit 42 and a second detection unit 44.

FIG. 4 is a (first) diagram illustrating an example in which enlarged display is performed by a display control unit 52.

FIG. 5 is a (second) diagram illustrating an example in which enlarged display is performed by the display control unit 52.

FIG. 6 is a diagram illustrating another display example of GUI objects 42A.

FIG. 7 is a flowchart illustrating an example of a display control process in the on-board operation device 40.

### DESCRIPTION OF THE EMBODIMENTS

Hereinafter, an on-board operation device according to an embodiment of the invention will be described with reference to the accompanying drawings.

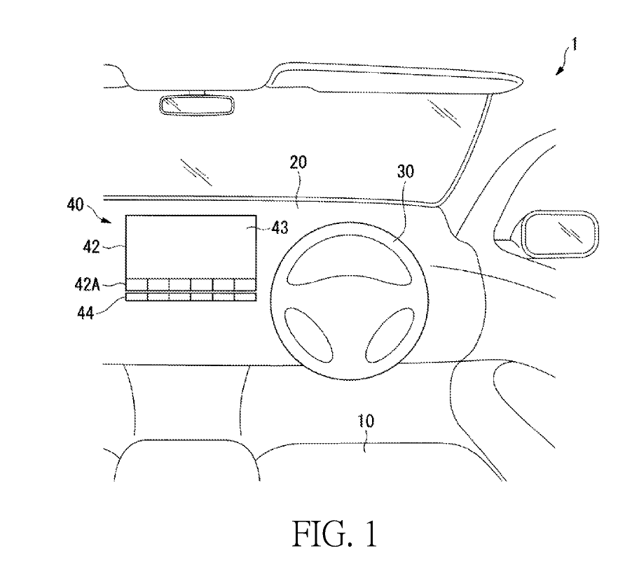

FIG. 1 is a diagram schematically illustrating a vehicle 1 which is equipped with an on-board operation device according to an embodiment. In the example illustrated in FIG. 1, the vehicle 1 includes a seat section 10, an instrument panel section (hereinafter referred to as an “instrument panel”) 20, a steering wheel 30, and an on-board operation device 40. The seat section 10 is a seat on which an occupant driving the vehicle 1 sits. The instrument panel 20 is disposed, for example, in front of the seat section 10 on which the occupant (a driver) driving the vehicle 1 sits. The instrument panel 20 is provided with a speedometer of the vehicle 1 and an operation unit and vent holes of an air-conditioning facility which are not illustrated.

The steering wheel 30 receives a steering operation of the vehicle 1 from an occupant. As illustrated in FIG. 1, the on-board operation device 40 is externally attached to or is embedded in the instrument panel 20. The on-board operation device 40 may be attached to, for example, an arbitrary place corresponding to a front passenger seat or a back seat.

A display unit 42 is constituted by a liquid crystal display (LCD), an organic electroluminescence (EL) display device, or the like. The display unit 42 receives operation details of an occupant (an operator) and displays information on a function of the received operation details. Examples of the function include a navigation function of performing route guidance to a destination for the vehicle 1, a radio function of outputting sound information transmitted at a predetermined frequency from a radio station from speakers, a media reproducing function of reproducing data stored in a digital versatile disc (DVD), a compact disc (CD), or the like, a telephone function of performing speech communication with an opposite party connected via a telephone line, and a terminal link function of linking a terminal device carried by an occupant to the on-board operation device 40, displaying a screen displayed on the terminal device on the screen of the display unit 42 or realizing the same function as the terminal device. The information on the function includes a screen for performing the function or contents such as a video, an image, and speech which are executed by the function. The on-board operation device 40 includes a global navigation satellite system (GNSS) receiver, map information (a navigation map), and the like when the navigation function is realized. The on-board operation device 40 may include a speaker that outputs sound or a microphone that inputs speech.

The display unit 42 displays, for example, one or more graphical user interface (GUI) objects 42A for switching to one of the above-mentioned functions. A GUI object 42A receives an operation corresponding to the GUI object 42A by an area in which the GUI object 42A is displayed (which may include an outer edge thereof) being touched. For example, the GUI object 42A is displayed in a shape of an icon, a button, a switch, a mark, a pattern, a figure, a symbol, or the like.

The display unit 42 includes a first detection unit 43 that detects an approach position of an operator's finger on a display surface thereof. The operator's finger is an example of an “indicator.” Examples of the indicator include another part of the operator's hand and a touch pen. The display unit 42 is a touch panel type display device having a function of displaying contents or the like and a function of receiving an approach position of an operator's finger to the display surface using the first detection unit 43.

The first detection unit 43 includes, for example, capacitance sensors that detect capacitance. The capacitance sensors are arranged at predetermined intervals in an area of the display surface of the display unit 42. The first detection unit 43 detects a position of the capacitance sensor of which the capacitance has changed to become equal to or greater than a threshold value among the arranged capacitance sensors as an operation position. The first detection unit 43 outputs position information indicating the detected operation position to a control unit 50 to be described later. The threshold value may be set to a value which is only exceeded by causing an operator's finger to touch the display surface of the display unit 42. In this case, the first detection unit 43 detects an approach of the finger by a touch on the display surface with the finger. Accordingly, since display control of the display unit 42 can be performed on the assumption that the first detection unit 43 has reliably been touched with the operator's finger, it is possible to prevent an erroneous operation.

The on-board operation device 40 includes a second detection unit 44 in addition to the display unit 42 and the first detection unit 43. The second detection unit 44 is disposed at an outer edge of the display surface of the display unit 42 and detects an approach position of an operator's finger.

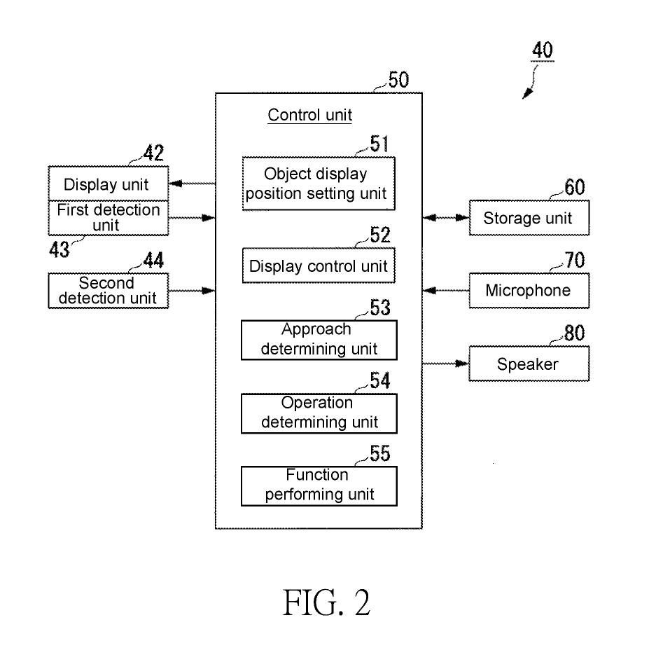

FIG. 2 is a diagram illustrating an example of a functional configuration of the on-board operation device 40. The on-board operation device 40 includes the display unit 42, the first detection unit 43, the second detection unit 44, a control unit 50, a storage unit 60, a microphone 70, and a speaker 80.

The second detection unit 44 includes a plurality of capacitance sensors which are arranged in the arrangement direction of the GUI objects 42A displayed on the display unit 42, and detects a capacitance of each capacitance sensor. The second detection unit 44 detects a position of the capacitance sensor of which the capacitance is changed to be equal to or greater than a threshold value as an operation position. The second detection unit 44 outputs position information indicating the detected position to the control unit 50. The threshold value may be set to a value which is exceeded by causing an operator's finger to touch the second detection unit 44. In this case, the second detection unit 44 detects the approach of the finger by the touch on the display surface with the finger. Accordingly, since display control of the display unit 42 can be performed on the assumption that the second detection unit 44 has reliably been touched with the operator's finger, it is possible to prevent an erroneous operation.

The capacitance sensors which are used for the first detection unit 43 and the second detection unit 44 may be capacitance sensors of a surface type (contact type) capacitance system in which a capacitance is changed by a touch on the surfaces of the detection units with an operator's finger or a projection type (non-contact type) capacitance system in which a capacitance is changed by causing an operator's finger to approach the display surfaces within a predetermined distance. As the first detection unit 43 and the second detection unit 44, pressure sensors using a resistive membrane, position sensors using ultrasonic surface acoustic waves, or positions sensors using infrared rays or cameras may be used instead of the capacitance sensors. Sensors that cause a weak current to flow always and detect a change in resistance due to a touch or the like may be used as the second detection unit 44. Each of the first detection unit 43 and the second detection unit 44 may include one sensor and may detect a position (coordinate) which is touched or approached in the sensor.

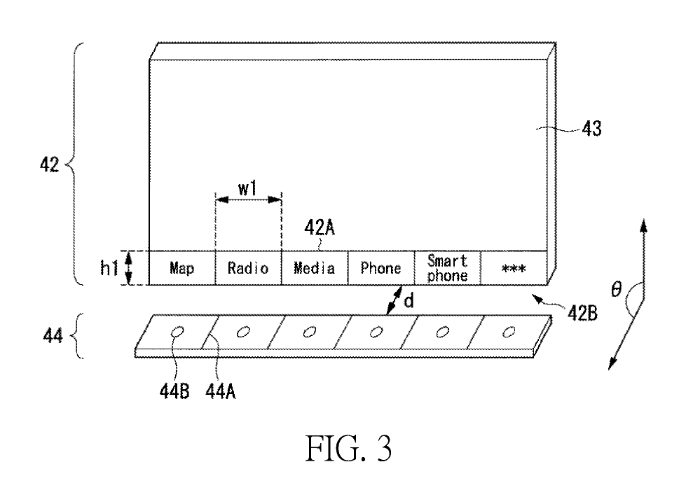

FIG. 3 is a diagram illustrating an arrangement example of the GUI objects 42A displayed on the display unit 42 and the second detection unit 44. The second detection unit 44 is disposed at the outer edge of the display unit 42 to be inclined forward with respect to the display surface of the display unit 42. An angle θ formed by the display unit 42 and the second detection unit 44 ranges, for example, from about 75 degrees to 180 degrees. The angle θ may be an angle corresponding to the shape of the instrument panel 20 or the like.

A distance d between the display unit 42 and the second detection unit 44 is preferably a distance at which the first detection unit 43 and the second detection unit 44 can simultaneously output a detection result based on the length of a finger or the size of a hand and is, for example, less than about 3 [cm]. The distance d may be set to substantially zero such that the display unit 42 and the second detection unit 44 are substantially continuous. The display unit 42 and the second detection unit 44 may be formed integrally, but separately. At least one of the display unit 42 and the second detection unit 44 may be embedded in the instrument panel 20 or may be installed on the surface of the instrument panel 20.

In the display unit 42, one or more GUI objects 42A are displayed to be biased to at least one end 42B. In the example illustrated in FIG. 3, the GUI objects 42A are displayed at the lower end of the display surface of the display unit 42. The display position of the GUI objects 42A is not limited to the example illustrated in FIG. 3. For example, the GUI objects 42A may be displayed in at least one of the ends 42B such as an upper end, a lower end, a left end, and a right end of the display surface.

Details correlated with a page displayed on the display unit 42 are assigned to the GUI objects 42A. In FIG. 3, a “Map” button for displaying a current location or switching to a navigation function, a “Radio” button for switching to a radio function, a “Media” button for switching to a function of reproducing media such as a DVD, a “Phone” button for switching to a telephone function, a “Smartphone button” for switching to a terminal link function, and a “***” button for displaying a button corresponding to another function are displayed as examples of the GUI objects 42A. The types or the number of GUI objects 42A to be displayed are not limited thereto, and for example, a GUI object for turning on/off a screen display or a GUI object for adjusting a sound volume of sound to be output may be displayed.

Each GUI object 42A is displayed, for example, in an area with the same size (w1×h1 in FIG. 3). The shape of the GUI object 42A is not limited to a rectangle, and may be a circle or an ellipse. The GUI objects 42A are normally displayed on the display screen of any layer regardless of details displayed on the display screen. The display screen of any layer is, for example, a display screen of a layer other than a start screen of the on-board operation device 40 or a display screen of detailed functions.

The second detection unit 44 may include a protective cover for protecting the capacitance sensors on the surfaces of the capacitance sensors. The protective cover is formed of a resin or the like. On the front surface or the rear surface of the protective cover, boundaries 44A for defining detection areas of the second detection unit 44 are disposed to be visually recognizable or tactually recognizable to correspond to the display areas of the GUI objects 42A displayed on the display unit 42. The boundaries 44A may be formed of, for example, a concave portion, a convex portion, or a notch or a line or a shape may be formed on the surface of the protective cover. Accordingly, an operator can easily recognize the boundaries corresponding to the GUI objects 42A visually or tactually and can easily select a target GUI object 42A. As illustrated in FIG. 3, in the second detection unit 44, a light emitter such as a light emitting diode (LED) 44B may be disposed in at least a part of the surface of the protective cover.

The control unit 50 includes, for example, an object display position setting unit 51, a display control unit 52, an approach determining unit 53, an operation determining unit 54, and a function performing unit 55.

The object display position setting unit 51 sets display position information including details and display positions of the GUI objects 42A. A display position is, for example, coordinate information on the display surface of the display unit 42. The display positions of the GUI objects 42A may be set to be preset for each function displayed on the display unit 42, or may be arbitrarily set by an operator's setting operation. The display position information of the GUI objects 42A which are set by the object display position setting unit 51 is stored in the storage unit 60.

The display control unit 52 displays the GUI objects 42A at predetermined positions on the display unit 42 based on the display position information stored in the storage unit 60. The display control unit 52 displays an image or contents of a layer before the GUI objects 42A are displayed. The display control unit 52 displays an area in which the GUI objects 42A are displayed and an area in which performance results (for example, contents) of the processes corresponding to the GUI objects 42A are displayed on the display surface of the display unit 42.

The approach determining unit 53 determines whether an operator's finger approaches the second detection unit 44 based on a signal input from the second detection unit 44 and additionally recognizes an approach position of the operator's finger. The second detection unit 44 may have only a function of outputting a signal indicating a capacitance, and the approach determining unit 53 may compare the capacitance with a threshold value and determine whether the operator's finger approaches the second detection unit 44.

The display control unit 52 receiving the determination result enlarges and displays the GUI object 42A corresponding to the approach position of the operator's finger in the second detection unit 44. The GUI object 42A corresponding to the approach position is, for example, a GUI object 42A which is displayed closest to the approach position.

The display control unit 52 may turn on the LED 44B corresponding to the approach position of the operator's finger in the second detection unit 44. The LED 44B may have a single color or may have different colors depending on the position at which the LED 44B is disposed. By turning on the LED 44B, or the like, the operator can easily understand at which position on the second detection unit 44 the operator's finger has been detected.

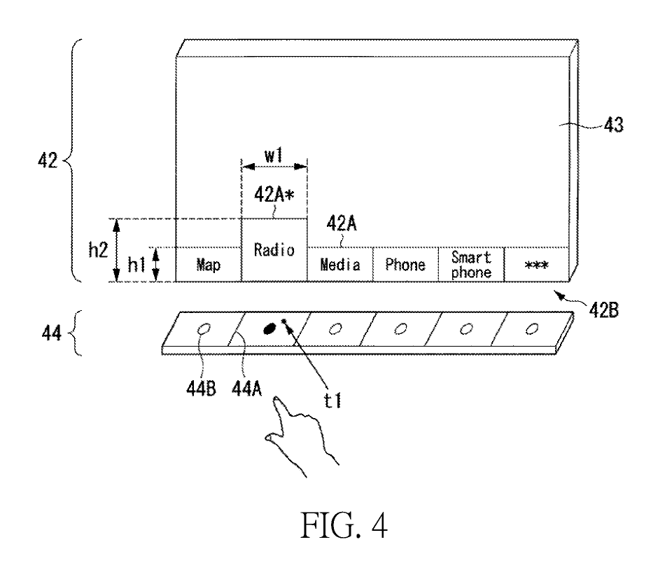

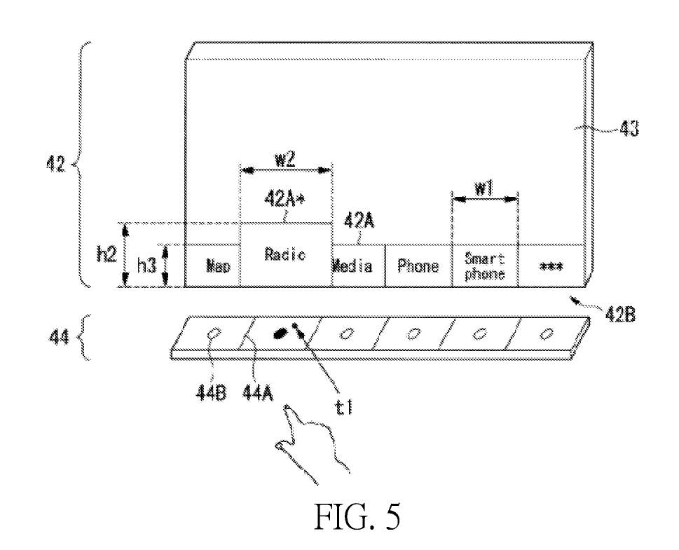

FIGS. 4 and 5 are diagrams illustrating an example in which enlarged display is performed by the display control unit 52. When information indicating an approach position is input from the approach determining unit 53, the display control unit 52 enlarges and displays the GUI object 42A corresponding to the approach position on the display unit 42 with reference to the display position information of the GUI objects 42A stored in the storage unit 60.

In the example illustrated in FIG. 4, the display control unit 52 enlarges and displays a GUI object 42A* corresponding to an approach position (t1 illustrated in FIG. 4) of the second detection unit 44 among the GUI objects 42A displayed on the display unit 42 to at least one side opposite to the side on which the second detection unit 44 is disposed. For example, the GUI object 42A* is enlarged and displayed in the height direction (the vertical direction) with the horizontal width set to be constant (w1). The enlarged height h2 is about two or three times (an enlargement ratio of 200% to 300%) the non-enlarged height h1. The height h1 is, for example, about 5 [mm] to 10 [mm], but may be set depending on the screen size of the display unit 42 or the number of GUI objects 42A displayed on the display unit 42. When the GUI objects 42A are arranged at the right end or the left end of the display surface, the display control unit 52 enlarges and displays the GUI object 42A* on at least one side opposite to the side on which the second detection unit 44 is disposed in the width direction (the horizontal direction) with the height of the GUI object 42A* kept constant. Accordingly, it is possible to enlarge and display a target GUI object without hiding another GUI object.

In the example illustrated in FIG. 4, the display control unit 52 may turn on the LED 44B corresponding to part t1 in the areas of the second detection unit 44 which are defined by the boundaries 44A. The display control unit 52 may enlarge characters or the like shown in the area occupied by the GUI object 42A* which has been enlarged and displayed or may display the GUI object 42A* which has been enlarged and displayed in a color different from that of the other GUI objects 42A. Accordingly, by enlarging and displaying the GUI object 42A to correspond to the position of the operator's finger, it is possible to improve visibility for an operator. The on-board operation device 40 can allow an operator to easily perform an operation of selecting the GUI objects 42A.

When a change in capacitance is detected by the second detection unit 44, the display control unit 52 may enlarge and display all the GUI objects 42A displayed on the display unit 42 at a first magnification and may further enlarge and display the GUI object 42A* corresponding to the approach position detected by the second detection unit 44 at a second magnification larger than the first magnification.

In the example illustrated in FIG. 5, the display control unit 52 enlarges and displays the GUI object 42A in the width direction as well as the height direction. For example, when an operator's finger approaches part t1 of the second detection unit 44, the display control unit 52 enlarges and displays all the GUI objects 42A displayed on the display unit 42 in the height direction at a first enlargement ratio (for example, 120% to 150%) with respect to the non-enlarged size. In this case, the size of the GUI objects 42A is w1×h3 illustrated in FIG. 5. In addition, the display control unit 52 enlarges and displays the GUI object 42A* corresponding to the position of part t1 at a second enlargement ratio (for example, 200% to 300%) which is larger than the first enlargement ratio with respect to the non-enlarged width w1 and the non-enlarged height h1. As a result, the size of the GUI object 42A* is w2×h2 illustrated in FIG. 5.

Accordingly, in a state in which the second detection unit 44 detects an approach position, all the objects can be made to be visually recognizable by displaying all the GUI objects 42A at the first enlargement ratio. By further displaying the GUI object 42A* corresponding to the approach position at the second enlargement ratio which is larger than the first enlargement ratio, the operation of selecting the GUI objects 42A can be easily and reliably performed.

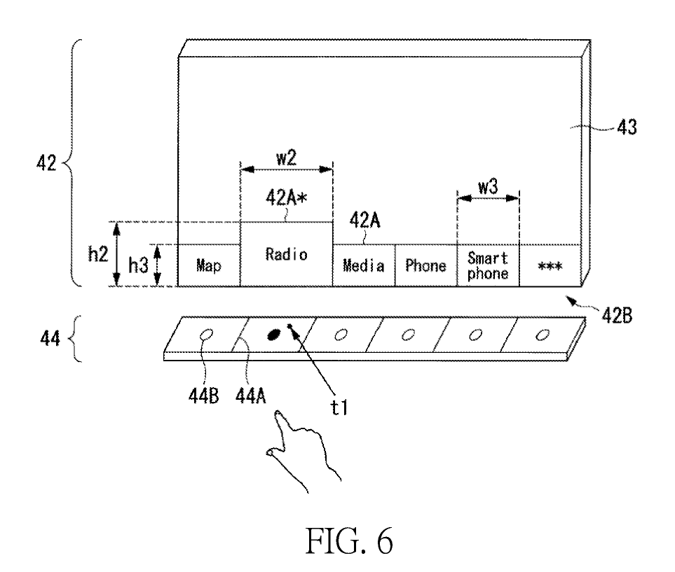

As illustrated in FIG. 6, when one GUI object 42A is enlarged and displayed in the width direction and the height direction, the display control unit 52 may adjust the size of one GUI object 42A and display the GUI object 42A such that at least a part of another GUI object 42A is not hidden. FIG. 6 is a diagram illustrating another display example of the GUI objects 42A.

In the example illustrated in FIG. 6, when an operator's finger approaches part t1 of the second detection unit 44, the display control unit 52 enlarges and displays all the GUI objects 42A displayed on the display unit 42 at the first enlargement ratio and further enlarges and displays the GUI object 42A* corresponding to the position of part t1 at the second enlargement ratio. At this time, when at least a part of the GUI objects 42A is hidden due to the above-mentioned enlargement, the display control unit 52 reduces the width of the GUI objects 42A, which have been enlarged and displayed at the first enlargement ratio, at a predetermined reduction ratio. As a result, the size of each GUI object 42A is w3×h3 illustrated in FIG. 6. The reduction ratio may be the same or different for all the GUI objects 42A. Some GUI objects 42A (for example, the GUI objects 42A adjacent to the GUI object 42A*) among all the GUI objects 42A may be reduced.

Accordingly, even when the GUI object 42A* corresponding to the approach position is enlarged and displayed, the selecting operation can be easily and reliably performed without hiding another GUI object 42A.

In the example illustrated in FIGS. 5 and 6, similarly to the example illustrated in FIG. 4, the display control unit 52 may turn on the LED 44B corresponding to part t1 among the areas of the second detection unit 44 which are defined by the boundaries 44A.

When one GUI object 42A is enlarged and displayed, the display control unit 52 may display the GUI object 42A to be enlarged at the center or the like of the display surface. When an approach position is not detected by the first detection unit 43 even after a predetermined time after the GUI object 42A is enlarged and displayed, the display control unit 52 returns the enlarged and displayed GUI object 42A to an original size or position or turns off the turned-on LED 44. When the capacitance of the capacitance sensor is changed from a value equal to or greater than a threshold value to a value less than the threshold value, the display control unit 52 may return the enlarged GUI object 42A to the original size or may turn off the turned-on LED 44B. Accordingly, it is possible to rapidly return the enlarged GUI object to the original state.

The operation determining unit 54 determines whether an operator's finger approaches the first detection unit 43 and recognizes the approach position of the operator's finger, based on a signal input from the first detection unit 43. The first detection unit 43 may have only a function of outputting a signal indicating a capacitance and the operation determining unit 54 may compare the capacitance with a threshold value and determine whether the operator's finger has approached the first detection unit 43.

The operation determining unit 54 determines whether the coordinate of the approach position on the display surface of the display unit 42 is in the display area of the GUI object 42A displayed on the display unit 42. When the approach position is in the display area of the displayed GUI object 42A, the operation determining unit 54 performs the function corresponding to the GUI object 42A using the function performing unit 55.

The function performing unit 55 performs a process corresponding to the GUI object 42A based on the determination result of the operation determining unit 54. For example, the function performing unit 55 calls the function corresponding to the GUI object 42A displayed at the approach position from the storage unit 60 or the like and performs the called function. For example, the function performing unit 55 may switch the screen to a screen for performing the function corresponding to the GUI object 42A or receives input of a variety of information required for performing the function and then may perform the function based on the received information. The function performing unit 55 is an example of the “process performing unit.”

According to the arrangement of the display unit 42 and the second detection unit 44 illustrated in FIGS. 3 to 5, an operator can perform an operation of selecting one GUI object 42A displayed on the display unit 42 by only slightly moving a finger after the GUI objects 42A are enlarged and displayed on the display unit 42 by causing the finger to approach the second detection unit 44. Accordingly, it is possible to improve operability of the selecting operation.

The storage unit 60 is embodied, for example, by a nonvolatile storage medium such as a read only memory (ROM), a flash memory, a hard disk drive (HDD), or an SD card and a volatile storage medium such as a random access memory (RAM) or a register. The storage unit 60 stores a variety of setting information such as the above-mentioned display position information, the enlargement ratio of the GUI objects 42A, or a time in which the GUI objects 42A are kept enlarged, programs for performing various functions of the on-board operation device 40, programs for performing a display control process in this embodiment, and the like. The microphone 70 receives a speech input to the on-board operation device 40. The speaker 80 outputs speech based on details displayed on the display unit 42.

Process Flow

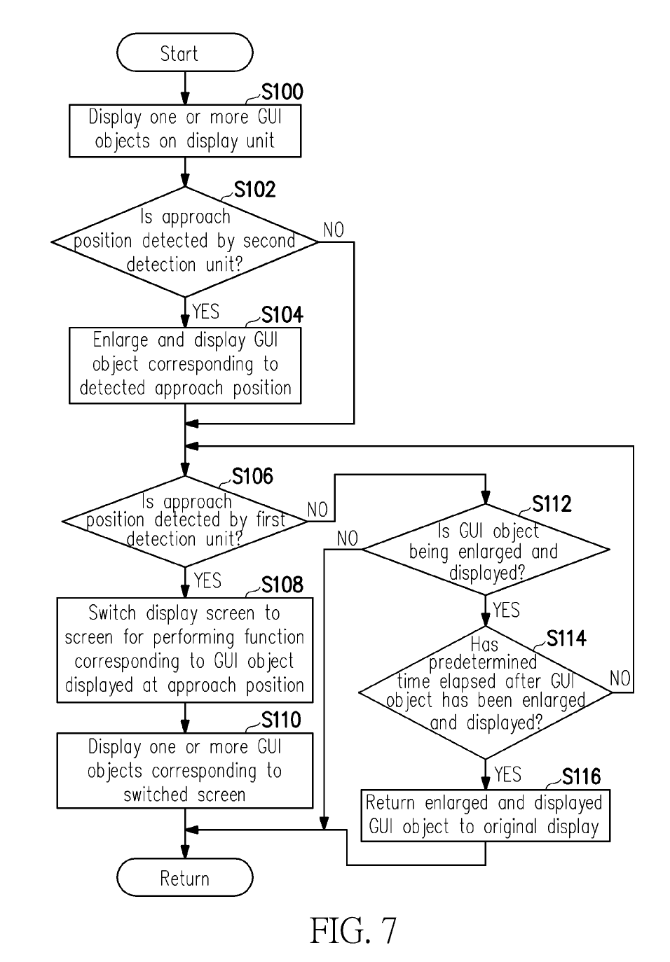

The display control process in the on-board operation device 40 will be described below with reference to a flowchart. FIG. 7 is a flowchart illustrating an example of the display control process in the on-board operation device 40. The process flow of the flowchart is repeatedly performed at predetermined intervals.

First, the display control unit 52 displays one or more GUI objects 42A on the display unit 42 based on the display position information of the GUI objects 42A set by the object display position setting unit 51 (Step S100). Then, the approach determining unit 53 determines whether an approach position is detected by the second detection unit 44 (Step S102). When an approach position is detected, the display control unit 52 enlarges and displays the GUI object 42A corresponding to the approach position (the GUI object 42A*) among one or more GUI objects 42 displayed on the display unit 42 based on the approach position detected by the second detection unit 44 (Step S104).

Then, the operation determining unit 54 determines whether an approach position of the operator's finger to the display surface of the display unit 42 is detected by the first detection unit 43 (Step S106). When an approach position is detected by the first detection unit 43, the function performing unit 55 switches the display screen to a screen for performing the function corresponding to the GUI object 42A displayed at the approach position (Step S108). Then, the display control unit 52 displays one or more GUI objects 42A corresponding to the switched screen on the display unit 42 (Step S110).

When it is determined in the process of Step S106 that an approach position is not detected by the first detection unit 43, the display control unit 52 determines whether a GUI object 42A is being enlarged and displayed (Step S112). When an object is being enlarged and displayed, the display control unit 52 determines whether a predetermined time has elapsed after the GUI object 42A has been enlarged and displayed (Step S114). The predetermined time ranges, for example, from two seconds to five seconds. When the predetermined time has not elapsed after the GUI object 42A has been enlarged and displayed, the process flow returns to Step S106. When the predetermined time has elapsed after the GUI object 42A has been enlarged and displayed, the display control unit 52 returns the enlarged and displayed GUI object 42A to the original display (Step S116). Accordingly, the process flow of the flowchart ends. When it is determined in Step S112 that a GUI object 42A is not being enlarged and displayed, the process flow of the flowchart ends.

In the above-mentioned embodiment, the second detection unit 44 may be made to have a higher resolution and defined positions corresponding to the GUI objects 42A may be controlled variably. For example, the second detection unit 44 may detect an approach position in a smaller range by setting the arrangement pitch of a plurality of capacitance sensors to be shorter than the width of the GUI objects 42A. Accordingly, even when the number of GUI objects 42A displayed at the end 42B of the display unit 42 increases and the width decreases, it is possible to detect one area of the areas corresponding to the GUI objects 42A which is approached by an operator's finger. As a result, the GUI objects 42A can flexibly cope with a change in size of the GUI objects 42A. The boundaries 44A in the protective cover may be changed depending on the size of the GUI objects 42A using a transparent liquid crystal or the like.

As described above, according to this embodiment, since the on-board operation device 40 includes a detection unit (the second detection unit 44) other than the first detection unit 43 that detects an approach position of an indicator to the display surface of the display unit 42 at an outer edge of the display surface and includes the display control unit that detects the approach position of the indicator using the second detection unit 44 and enlarges and displays the GUI object 42A based on the detected approach position, it is possible to easily enlarge and display a GUI object desired by an operator. As a result, it is possible to improve operability for selecting the GUI object 42A.

According to this embodiment, since a GUI object 42A is enlarged and displayed when an approach of an indicator is detected instead of initially enlarging and displaying the GUI object, it is possible to make the display unit 42 compact. Accordingly, the display unit 42 can be disposed even when the instrument panel 20 of the vehicle 1 has a finite space.

While the invention has been described above with reference to an embodiment, the invention is not limited to the embodiment and can be modified in various forms without departing from the gist of the invention.

What is claimed is:

1. An on-board operation device comprising:
a display unit configured to display a GUI object;
a first detection unit configured to detect an approach position of an indicator on a display surface of the display unit;
a process performing unit configured to perform a process corresponding to the GUI object displayed at the approach position detected by the first detection unit;
a second detection unit disposed at an outer edge of the display surface of the display unit and configured to detect an approach position of the indicator; and
a display control unit configured to enlarge and display the GUI object on the display unit when the approach position of the indicator is detected by the second detection unit.

2. The on-board operation device according to claim 1, wherein a plurality of the GUI objects are displayed on the display unit, and
the display control unit enlarges and displays the GUI object corresponding to the approach position among the plurality of GUI objects on the display unit based on the approach position of the indicator detected by the second detection unit.

3. The on-board operation device according to claim 2, wherein the display control unit enlarges and displays the GUI object corresponding to the approach position to at least a side opposite to a side on which the second detection unit is disposed on the display unit.

4. The on-board operation device according to claim 1, wherein the display control unit enlarges and displays the GUI object on the display unit by detecting a touch on the second detection unit with the indicator.

5. The on-board operation device according to claim 2, wherein the display control unit enlarges and displays the GUI object on the display unit by detecting a touch on the second detection unit with the indicator.

6. The on-board operation device according to claim 3, wherein the display control unit enlarges and displays the GUI object on the display unit by detecting a touch on the second detection unit with the indicator.

7. The on-board operation device according to claim 1, wherein the plurality of GUI objects are displayed to be biased to an end of the display surface, and
the second detection unit is disposed along the end to which the plurality of GUI objects are biased.

8. The on-board operation device according to claim 2, wherein the plurality of GUI objects are displayed to be biased to an end of the display surface, and
the second detection unit is disposed along the end to which the plurality of GUI objects are biased.

9. The on-board operation device according to claim 3, wherein the plurality of GUI objects are displayed to be biased to an end of the display surface, and
the second detection unit is disposed along the end to which the plurality of GUI objects are biased.

10. The on-board operation device according to claim 1, wherein the second detection unit is provided with boundary lines which are visually recognizable or tactually recognizable to correspond to shapes of the GUI objects displayed on the display unit.

11. The on-board operation device according to claim 2, wherein the second detection unit is provided with boundary lines which are visually recognizable or tactually recognizable to correspond to shapes of the GUI objects displayed on the display unit.

12. The on-board operation device according to claim 3, wherein the second detection unit is provided with boundary lines which are visually recognizable or tactually recognizable to correspond to shapes of the GUI objects displayed on the display unit.

13. The on-board operation device according to claim 1, wherein the second detection unit is formed to be inclined forward with respect to the display surface of the display unit.

14. The on-board operation device according to claim 2, wherein the second detection unit is formed to be inclined forward with respect to the display surface of the display unit.

15. The on-board operation device according to claim 1, wherein the second detection unit includes a capacitance sensor.

16. The on-board operation device according to claim 2, wherein the second detection unit includes a capacitance sensor.

17. The on-board operation device according to claim 1, wherein details correlated with a page displayed on the display unit are assigned to the GUI objects and the GUI objects are normally displayed on a display screen of any layer regardless of the details displayed on the display screen.

18. The on-board operation device according to claim 2, wherein details correlated with a page displayed on the display unit are assigned to the GUI objects and the GUI objects are normally displayed on a display screen of any layer regardless of the details displayed on the display screen.

19. The on-board operation device according to claim 1, wherein the display control unit displays an area in which the GUI objects are displayed and an area in which results of processes corresponding to the GUI objects are displayed on the display surface of the display unit.

20. The on-board operation device according to claim 2, wherein the display control unit displays an area in which the GUI objects are displayed and an area in which results of processes corresponding to the GUI objects are displayed on the display surface of the display unit.
